(19) United States
(12) Patent Application Publication
(10) Pub. No.: US 2016/0243817 A1
(43) Pub. Date: Aug. 25, 2016

(54) COMPOSITION FOR INSULATION-COATING SHIELD CAN AND METHOD FOR INSULATION-COATING SHIELD CAN BY USING SAME

(71) Applicant: Jaeho ROH, Daegu (KR)

(72) Inventor: Jaeho ROH, Daegu (KR)

(21) Appl. No.: 15/025,876

(22) PCT Filed: Jul. 22, 2015
(86) PCT No.: PCT/KR2015/007598

§ 371 Date: Mar. 29, 2016

(30) Foreign Application Priority Data
Jul. 25, 2014 (KR) 10-2014-0094780

(51) Int. Cl. B41F 23/04; H01B 3/40; C09D 163/10

(52) U.S. Cl. CPC B41F 23/04; C09D 163/10; H01B 3/40; B41J 11/002

(57) ABSTRACT

Provided are an insulation coating composition for a shield-can and an insulation coating method for a shield-can using the composition. The insulation coating composition for an inner surface of a shield-can according to embodiments of the present invention is used in a printing process for insulation coating of a shield-can and contains an epoxy acrylate resin and a curing agent. Accordingly, costs can be reduced, the process can be sped up and scaled up in the process of forming an insulating film on an inner surface of a shield-can.

### TECHNICAL FIELD

Embodiments of the present invention relate to an insulating coating composition and an insulation coating method using the composition, and, more particularly, to an insulation coating composition for a shield-can and an insulation coating method using the composition.

### BACKGROUND ART

In recent years, thanks to the rapid development of electronic and communications technology, it has become technically possible to compact unit circuits with various functions within a small space for use. Accordingly, a problem of electromagnetic interference (EMI), which causes a malfunction of a device due to a mutual interference of electromagnetic waves (EMWs) generated from each circuit, occurs among neighboring circuits.

In addition to such a problem of EMI, it has been continuously reported that an EMW generated from an electronic device raises a temperature of living tissue cells by a thermal reaction, thus affecting a human body unfavorably by weakening an immune system, causing gene transformation, or the like; hence, a need for an EMW shield is more emphasized in recent years to prevent an EMW from affecting a human body.

In general, EMW shielding means to block between an external EMW source and an object to be protected with a shielding material to inhibit the transmission of an EMW into the interior and protect a human body or a device that is susceptible to an EMW.

Currently, the most commonly and widely used method among EMW shielding methods is to use a shield-can, which is an electrically conductive can, and the method typically uses a metal plate or a synthetic resin to which electrically conductive metals (Fe, Cu, Ni, etc.) are added, which is produced into a shape of a can or a box and put on an upper part of a circuit element to shield an EMW that was generated from a circuit element. To cover the circuit element, shield-cans are produced by press working a thin plate into a shape of a box with an opening only at a lower part.

Also, an insulating film is formed on an inner surface of the shield-can so that the circuit elements and the shield-can can be isolated. Therefore, conventionally, insulating tape was attached to the inner surface of the shield-can to form an insulating film. However, in this case, the insulating tape had to be attached individually by hand, to an inner surface of the shield-can, thus expenses including labor costs were high and a process speed was low. Also, scaling-up was difficult to achieve.

### DISCLOSURE

### Technical Problem

Hence, embodiments of the present invention have been designed to solve the above problems and are directed to providing an insulation coating composition for a shield-can that results in a reduced cost, increased process speed, and scaling-up; and an insulation coating method for a shield-can using the composition.

### Technical Solution

An embodiment of the present invention provides an insulation coating composition for a shield-can. The composition is used in a printing process for insulation coating a shield-can and includes an epoxy acrylate resin and a curing agent.

The insulation coating composition for a shield-can may contain the epoxy acrylate resin at 5 wt % to 60 wt % and the curing agent at 0.2 wt % to 10 wt %, wherein the epoxy acrylate resin may contain at least one selected from the group consisting of a bisphenol-A epoxy acrylate resin, a bisphenol-F epoxy acrylate resin, a novolac epoxy acrylate resin, a cresol-novolac epoxy acrylate resin, and a biphenyl epoxy acrylate resin, and the curing agent may contain at least one selected from the group consisting of a monoamine, a diamine, a tetramine, an aliphatic amine, a modified-aliphatic amine, an aromatic amine, phtalic anhydride, a polyamide resin, a polysulfide, a BF3-complex, a phenol resin, and dicyandiamide. An acid value of the epoxy acrylate resin may range from 0.5 mg-KOH/g to 150 mg-KOH/g. Also, the insulation coating composition for a shield-can may further contain a surface levelling agent, and the surface levelling agent may contain at least one selected from the group consisting of poly(alkyl acrylate), poly(alkyl vinyl ether), cellulose acetate butyrate (CAB), dimethylpolysiloxane, methyl phenyl polysiloxane, organic modified polysiloxane, solutions of a silicone-modified polymer, and fluorine-based surfactants. Also, the insulation coating composition for a shield-can may further contain a dye, and the dye may contain at least one selected from the group consisting of titanium oxide, zinc oxide, carbon black, iron black, organic pigments, and organic dyes. In addition, the insulation coating composition for a shield-can may further contain a surfactant.

Another embodiment of the present invention provides an insulation coating composition for a shield-can. The composition contains an epoxy acrylate resin at 5 wt % to 60 wt %, a curing agent at 0.2 wt % to 10 wt %, a surface levelling agent at 0.2 wt % to 10 wt %, and a solvent as the remainder.

Still another embodiment of the present invention provides an insulation coating method for an inner surface of a shield-can using an insulation coating composition for a shield-can. The insulation coating method includes preparing an insulation coating composition for a shield-can, which contains an epoxy acrylate resin and a curing agent and is used in a printing process for insulation coating of a shield-can, coating the insulation coating composition for a shield-can on an inner surface of the shield-can by employing a printing process, and heat-treating the insulation coating composition for a shield-can that has been coated.

The printing process may be roll-to-roll printing, gravure printing, off-set printing, flexo printing, screen printing, inkjet printing, or a dispensing process, and the heat-treatment may be carried out at a temperature in a range of 100° C. to 200° C. for 1 minute to 60 minutes.

### Advantageous Effects

According to an embodiment of the present invention, an insulation coating composition for a shield-can and an insulation coating method for a shield-can using the composition can reduce costs, speed up and scale up a process of forming an insulating film on an inner surface of a shield-can.

### DESCRIPTION OF DRAWINGS

FIG. 1 is a schematic diagram for showing an insulation coating process of an inner surface of a shield-can according to one embodiment of the present invention.

FIG. 2 is a cross-sectional view for showing a circuit board that includes a shield-can according to one embodiment of the present invention.

### EMBODIMENTS OF THE INVENTION

Hereinafter, example embodiments of the present invention will be described in detail using embodiments of the present invention and with reference to the accompanying drawings. However, the following examples are not limited to the example embodiments described herein but may be embodied in a different form. The same numerals denote the same elements throughout the specification.

Also, a ‘shield-can’, which is described throughout this specification, refers to a shield for an electromagnetic wave (EMW) shield that has a shape of a box with an opening at a lower part to be able to cover circuit elements disposed on a circuit board.

Insulation Coating Composition for Shield-Can

According to one embodiment of the present invention, the insulation coating composition for a shield-can is used in a printing process for insulation coating of a shield-can and contains an epoxy acrylate resin and a curing agent.

The epoxy acrylate resin may be prepared by mixing an acrylic monomer in an acetate-based solvent. The epoxy acrylate resin is a polymeric insulating material that has excellent properties in terms of electrical, thermal, and chemical aspects, and curing thereof is easy.

The epoxy acrylate resin may include at least one selected from the group consisting of a bisphenol-A epoxy acrylate resin, a bisphenol-F epoxy acrylate resin, a novolac epoxy acrylate resin, a cresol-novolac epoxy acrylate resin, and a biphenyl epoxy acrylate resin.

The epoxy acrylate resin may be contained in the insulation coating composition for a shield-can at 5 wt % to 60 wt %. When the epoxy acrylate resin is contained at less than 5 wt %, an insulating effect may be degraded, and when 60 wt % is exceeded, viscosity may increase so as to be inappropriate for a use in a printing process.

The curing agent serves to make a cured state by causing a crosslinking reaction of the epoxy acrylate having a two-dimensional linear structure, resulting in a structural change to a three-dimensional network structure. The curing agent may be contained in the insulation coating composition for a shield-can at 0.2 wt % to 10 wt %. When the curing agent is contained at less than 0.2 wt %, curing may not be achieved successfully, and when 10 wt % is exceeded, there is a risk of an occurrence of excessive curing, and an increase in material costs may result.

The curing agent may contain at least one selected from the group consisting of a monoamine, a diamine, a tetramine, an aliphatic amine, a modified-aliphatic amine, an aromatic amine, phtalic anhydride, a polyamide resin, a polysulfide, a BF3-complex, a phenol resin, and dicyandiamide.

An acid value of the epoxy acrylate resin may range from 0.5 mg-KOH/g to 150 mg-KOH/g. When the acid value of the epoxy acrylate resin is lower than 0.5 mg-KOH/g, reactivity of the epoxy acrylate resin and the curing agent degrades. Also, when the acid value of the epoxy acrylate resin exceeds 150 mg-KOH/g, an insulating effect of the insulation coating composition for a shield-can may be degraded.

In this case, the epoxy acrylate resin and the curing agent are dissolved in a solvent to prepare the insulation coating composition for a shield-can. The solvent serves to control the viscosity of the insulation coating composition for a shield-can.

The solvent may be a ketone compound, and the ketone compound may contain, but is not limited to, at least one selected from the group consisting of acetone, oxaloacetone, 2,4-pentanedione, cyclohexane, muscone, and tetracycline. Also, the solvent may be an acetate-based solvent, and the acetate-based solvent may contain at least one selected from the group consisting of propylene glycol monomethyl ether acetate (PGMEA), ethylene glycol monobutyl ether acetate, diethylene glycol monobutyl acetate, diethylene monoethyl ether acetate, n-propyl acetate, butyl acetate, and ethyl acetate; however, the solvent is not limited thereto, and any solvent that can dissolve the aforementioned epoxy acrylate resin and curing agent may be used.

The insulation coating composition for a shield-can may further contain a surface levelling agent. The surface levelling agent serves to improve a smoothness of a surface of an insulation coating film that is formed during insulation coating of an inner film of a shield-can using the insulation coating composition for a shield-can.

It is preferable that the surface levelling agent is contained in the insulation coating composition for a shield-can at 0.2 wt % to 10 wt %. When the surface levelling agent is contained less than 0.2 wt % or greater than 10 wt %, a surface of the insulation coating film may be uneven.

The surface levelling agent may contain at least one selected from the group consisting of poly(alkyl acrylate), poly(alkyl vinyl ether), cellulose acetate butyrate (CAB), dimethylpolysiloxane, methyl phenyl polysiloxane, organic modified polysiloxane, solutions of a silicone-modified polymer, and fluorine-based surfactants.

Also, the insulation coating composition for a shield-can may further contain a dye. The dye may secure the visibility of the insulation coating composition for a shield-can.

The dye may contain, but is not limited to, at least one selected from the group consisting of titanium oxide, zinc oxide, carbon black, iron black, organic pigments, and organic dyes.

Also, in addition to aforementioned substances, an adhesion promotor, a surfactant, a viscosity controlling agent, an antistatic agent, or the like may be further included, although not limited thereto, in the insulation coating composition for a shield-can.

Another embodiment of the present invention provides an insulation coating composition for a shield-can that contains an epoxy acrylate resin at 5 wt % to 60 wt %, a curing agent at 0.2 wt % to 10 wt %, a surface levelling agent at 0.2 wt % to 10 wt %, and a solvent as the remainder.

The curing agent of the insulation coating composition for a shield-can serves to make a cured state by causing a crosslinking reaction of the epoxy acrylate having a two dimensional linear structure, thus resulting in a structural change to a three-dimensional network. Also, the inclusion of the surface levelling agent may enable the maximization of surface smoothness of an insulation coating film that is formed during an insulation coating of an inner surface of a shield-can using the insulation coating composition for a shield-can.

In addition, for more detailed descriptions of the epoxy acrylate resin, the curing agent, the surface levelling agent, and the solvent, refer to the above descriptions.

Insulating Coating Method for Inner Surface of Shield-Can

Still another embodiment of the present invention provides an insulation coating method of an inner surface of a shield-can by utilizing an insulation coating composition for a shield-can.

First, an insulation coating composition for a shield-can, which is used in a printing process for a shield-can insulation coating and contains an epoxy acrylate resin and a curing agent is prepared.

For detailed descriptions of the insulation coating composition for a shield-can, refer to the above descriptions of the insulation coating composition for a shield-can.

Then, the insulation coating composition for a shield-can is coated on an inner surface of the shield-can using a printing process.

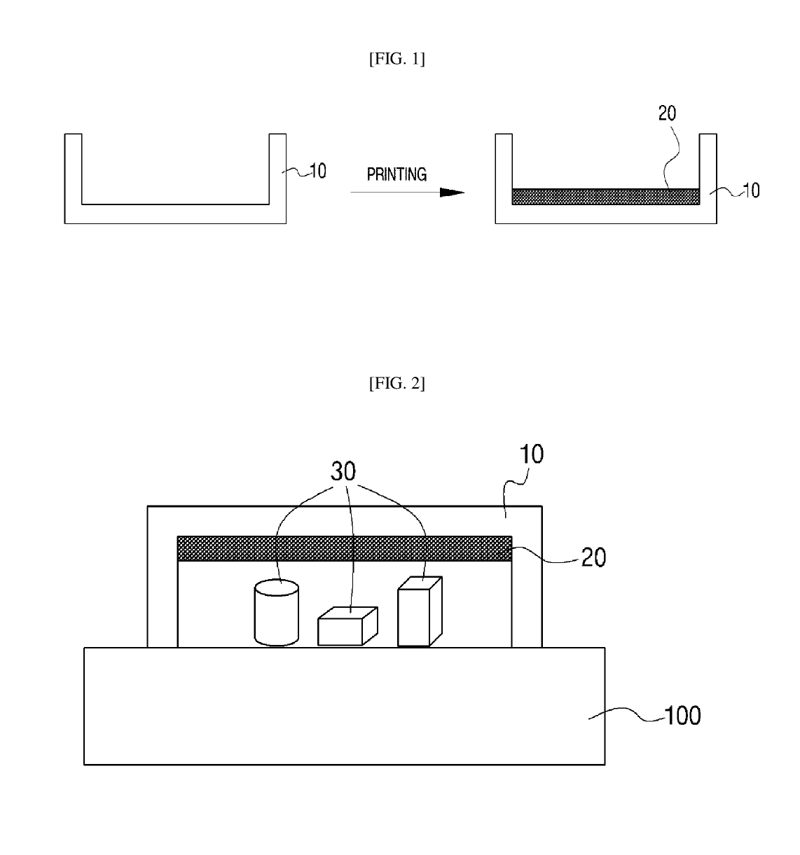

FIG. 1 is a schematic diagram for showing an insulation coating process of an inner surface of a shield-can according to one embodiment of the present invention.

As in FIG. 1, an inner surface of the shield-can 10 is coated with an insulation coating composition for a shield-can 20.

In this case, the printing process may be roll-to-roll printing, gravure printing, off-set printing, flexo printing, screen printing, inkjet printing, or a dispensing process.

Then, the coated insulation coating composition for a shield-can is heat-treated. The heat-treatment may be carried out at a temperature in a range of 100° C. to 200° C. for 1 minute to 60 minutes. When a temperature of the heat-treatment is lower than 100° C. or a duration of the heat-treatment is less than 1 minute, the hardness of the coated insulation coating composition for a shield-can may be reduced, and when the temperature of the heat-treatment exceeds 200° C. or the duration of the heat-treatment exceeds 60 minutes, the coated insulation coating composition for a shield-can may be excessively cured, resulting in structural instability.

FIG. 2 is a cross-sectional view for showing a circuit board that includes a shield-can according to one embodiment of the present invention.

As in FIG. 2, the shield-can 10 whose inner surface is insulation-coated with an insulation coating composition for a shield-can 20 may be disposed above a circuit board 100 to mutually isolate a circuit element 30 and the shield-can 10

Hereinafter, examples will be proposed for better understanding of embodiments of the present invention. However, the examples below are only intended to assist understanding of the embodiments and not to limit the embodiments thereto.

### Example 1

### Evaluation of Insulating Property of Insulating Film According to Content of Epoxy Acrylate Resin

Compositions for an insulation coating on an inner surface of a shield-can containing an amine-based curing agent (BF3-MEA: BF3-mono ethyl amine) at 4 wt %, a surface levelling agent (BYK-358N) at 1 wt %, and acetone (solvent) as the remainder were prepared, while varying a content of an epoxy acrylate resin within a range of 1 wt % to 60 wt %.

Then, the composition for an insulation coating on an inner surface of a shield-can was applied on an inner surface of a shield-can by utilizing an inkjet printing process and then baked at a temperature of 160° C. for 30 minutes to coat the inner surface of the shield-can with an insulating film.

Then, a surface resistivity of an insulating film formed on an inner surface of a shield-can that had been prepared was measured by a high resistance tester of Mitsubishi, Japan.

Test conditions and results are as shown in the following Table 1.

TABLE 1

| | Epoxy acrylate resin content (wt %) | | | | | | | |
|---|---|---|---|---|---|---|---|---|
| | 1 | 5 | 10 | 20 | 30 | 40 | 50 | 60 |
| BF3-MEA content | 4 | 4 | 4 | 4 | 4 | 4 | 4 | 4 |
| (wt %) | | | | | | | | |
| BYK-358N (wt %) | 1 | 1 | 1 | 1 | 1 | 1 | 1 | 1 |
| Solvent (acetone) | 94 | 90 | 85 | 75 | 65 | 55 | 45 | 35 |
| content (wt %) | | | | | | | | |
| Viscosity of | 2 | 2.9 | 4.1 | 6.4 | 10.3 | 34.2 | 59.1 | 82 |
| composition for | | | | | | | | |
| insulation coating | | | | | | | | |
| on inner surface | | | | | | | | |
| of shield-can (cps) | | | | | | | | |
| Surface resistivity | x | Δ | ∘ | ∘ | ∘ | ∘ | ∘ | ∘ |
| (Ω/cm²) | | | | | | | | |

(∘: surface resistivity value exceeds 3 × 10¹⁰, Δ: surface resistivity value ranges from 1 × 10⁹ to 3 × 10¹⁰, x: surface resistivity value is lower than 1 × 10⁹)

Referring to Table 1 above, it can be seen that, when the content of an epoxy acrylate resin is lower than 5 wt %, the surface resistivity is low for the shield-can insulating film that was formed on the inner surface of the shield-can, and, it can also be seen that, as the content of the solvent increases, the viscosity increases for the composition for an insulation coating on an inner surface of a shield-can.

In conclusion, it can be recognized that an excellent insulation property and a viscosity suitable for a printing process can be attained within a content range of an epoxy acrylate resin of 5 wt % to 60 wt %.

### Example 2

### Reliability Evaluation of Insulating Film According to Content of Curing Agent

Compositions for an insulation coating on an inner surface of a shield-can containing an epoxy acrylate resin at 20 wt %, a surface levelling agent (BYK-358N) at 1 wt %, and acetone (solvent) as the remainder were prepared, while varying a content of an amine-based curing agent (BF3-MEA: BF3-mono ethyl amine) within a range of 0.1 wt % to 10 wt %.

Then, the composition for an insulation coating on an inner surface of a shield-can was applied on an inner surface of a shield-can by an inkjet printing process, then baked at a temperature of 160° C. for 30 minutes to coat the inner surface of the shield-can with an insulating film.

Subsequently, to evaluate a peel off property, a PCT evaluation was performed using a PCT chamber from Hirayama Manufacturing Corporation, Japan. The PCT evaluation was conducted under conditions of a temperature of 121° C., pressure of 2 atm, and relative humidity (RH) of 100%.

Also, to evaluate a peel off property, Cosmopia from Hitachi Appliances, Inc., Japan was used to perform a constant temperature and humidity evaluation. The constant temperature and humidity evaluation was performed under conditions of a temperature of 85° C. and a relative humidity of 85%.

Test conditions and results are as shown in the following Table 2.

TABLE 2

| | Epoxy acrylate resin content (wt %) | | | | | | | |
|---|---|---|---|---|---|---|---|---|
| | 20 | 20 | 20 | 20 | 20 | 20 | 20 | 20 |
| BF3-MEA (wt %) | 0.1 | 0.2 | 0.3 | 0.5 | 1 | 3 | 5 | 10 |
| BYK-358N (wt %) | 1 | 1 | 1 | 1 | 1 | 1 | 1 | 1 |
| Solvent (acetone) | 78.9 | 78.8 | 78.7 | 78.5 | 78 | 76 | 74 | 69 |
| content (wt %) | | | | | | | | |
| Occurrence of | ∘ | x | x | x | x | x | x | x |
| peel-off (PCT Test) | | | | | | | | |
| Occurrence of peel- | ∘ | x | x | x | x | x | x | x |
| off (constant | | | | | | | | |
| temperature and | | | | | | | | |
| humidity Test) | | | | | | | | |

(∘: insulating film is separated from a shield-can, x: insulating film is not separated from a shield-can)

Referring to Table 2 above, it can be seen that the insulating film is separated from the shield-can, when a content of a curing agent is lower than 0.2 wt %.

In conclusion, it can be seen that a curing agent contained in the insulation coating composition for a shield-can has high reliability within a range of 0.2 wt % to 10 wt %.

### Example 3

### Evaluation of Smoothness of Insulating Film According to Content of Surface Levelling Agent

Compositions for an insulation coating on an inner surface of a shield-can containing an epoxy acrylate resin at 20 wt %, an amine-based curing agent (BF3-MEA: BF3-mono ethyl amine) at 4 wt %, and acetone (solvent) as the remainder were prepared, while varying a content of a surface levelling agent (BYK-358N) within a range of 0.1 wt % to 10 wt %.

Then, the composition for an insulation coating on an inner surface of a shield-can was applied on an inner surface of a shield-can by an inkjet printing process and then baked at a temperature of 160° C. for 30 minutes to form an insulating film on the inner surface of the shield-can.

Subsequently, five distinct points were selected from an insulating film. Then, thicknesses that correspond to the five points of the insulating film were measured using Bruker (formerly Veeco Instruments, Inc.), which is a non-contact thickness gauge.

Test conditions and results are as shown in the following Table 3.

TABLE 3

| | | Epoxy acrylate resin content (wt %) | | | | | | | |
|---|---|---|---|---|---|---|---|---|---|
| | | 20 | 20 | 20 | 20 | 20 | 20 | 20 | 20 |
| BF3-MEA (wt %) | | 4 | 4 | 4 | 4 | 4 | 4 | 4 | 4 |
| BYK-358N (wt %) | | 0.1 | 0.2 | 0.3 | 0.5 | 1 | 3 | 5 | 10 |
| Solvent (acetone) | | 75.9 | 75.8 | 75.7 | 75.5 | 75 | 73 | 71 | 66 |
| content (wt %) | | | | | | | | | |
| Insulating | Point 1 | 8.3 | 8.7 | 8.6 | 8.8 | 8.8 | 9.2 | 9.6 | 10.2 |
| film | Point 2 | 8.5 | 8.4 | 8.7 | 8.8 | 8.9 | 9.1 | 9.5 | 10.4 |
| thickness | Point 3 | 9.8 | 9.0 | 8.4 | 8.6 | 9.0 | 9.4 | 9.4 | 10.4 |
| (μm) | Point 4 | 8.2 | 8.5 | 8.9 | 8.5 | 9.0 | 9.2 | 9.4 | 10.1 |
| | Point 5 | 7.9 | 8.4 | 8.3 | 8.5 | 8.9 | 9.2 | 9.5 | 10.3 |

| | | | | | | | | |
|---|---|---|---|---|---|---|---|---|
| Maximum thickness (μm) | 9.8 | 9.0 | 8.9 | 8.8 | 9.0 | 9.4 | 9.6 | 10.4 |
| Minimum thickness (μm) | 7.9 | 8.4 | 8.3 | 8.5 | 8.8 | 9.1 | 9.4 | 10.1 |
| Average thickness (μm) | 8.5 | 8.6 | 8.6 | 8.6 | 8.9 | 9.2 | 9.5 | 10.3 |
| Standard deviation (μm) | 0.737 | 0.255 | 0.239 | 0.152 | 0.084 | 0.110 | 0.084 | 0.130 |

Referring to Table 3 above, it can be seen that, when a content of the surface levelling agent is 0.1 wt %, the thicknesses corresponding to the five points of the insulating film had a standard deviation of 0.737 μm, which signifies unevenness.

To conclude, it can be recognized that, when the content of the surface levelling agent ranges from 0.2 wt % to 10 wt %, an insulating film with excellent smoothness is formed.

While embodiments of the present invention have been described above, it will be understood that the embodiments of the present invention are not limited to the above examples and that those skilled in the art may variously modify and make changes to the embodiments without departing from the spirit and scope of embodiments of the present invention.

[List of Reference Numerals]

| | |
|---|---|
| 10: SHIELD-CAN | |
| 20: INSULATION COATING | |
| COMPOSITION FOR SHIELD-CAN | |
| 30: CIRCUIT ELEMENT | 100: CIRCUIT BOARD |

1. An insulation coating composition of a shield-can, the insulation coating composition used in a printing process for insulation coating of an inner surface of a shield-can and comprising an epoxy acrylate resin and a curing agent.

2. The insulation coating composition of claim 1 comprising:
the epoxy acrylate resin at 5 wt % to 60 wt %; and
the curing agent at 0.2 wt % to 10 wt %.

3. The insulation coating composition of claim 1, wherein the epoxy acrylate resin contains:
at least one selected from the group consisting of a bisphenol-A epoxy acrylate resin, a bisphenol-F epoxy acrylate resin, a novolac epoxy acrylate resin, a cresol-novolac epoxy acrylate resin, and a biphenyl epoxy acrylate resin.

4. The insulation coating composition of claim 1, wherein the curing agent contains at least one selected from the group consisting of a monoamine, a diamine, a tetramine, an aliphatic amine, a modified-aliphatic amine, an aromatic amine, phtalic anhydride, a polyamide resin, a polysulfide, a BF3-complex, a phenol resin, and dicyandiamide.

5. The insulation coating composition of claim 1, wherein an acid value of the epoxy acrylate resin ranges from 0.5 mg-KOH/g to 150 mg-KOH/g.

6. The insulation coating composition of claim 1, further comprising a surface levelling agent.

7. The insulation coating composition of claim 6, wherein the surface levelling agent contains at least one selected from the group consisting of poly(alkyl acrylate), poly(alkyl vinyl ether), cellulose acetate butyrate (CAB), dimethylpolysiloxane, methyl phenyl polysiloxane, organic modified polysiloxane, solutions of a silicone-modified polymer, and fluorine-based surfactants.

8. The insulation coating composition of claim 1, further comprising a dye.

9. The insulation coating composition of claim 8, wherein the dye contains at least one selected from the group consisting of titanium oxide, zinc oxide, carbon black, iron black, organic pigments, and organic dyes.

10. The insulation coating composition of claim 1, further comprising a surfactant.

11. An insulation coating composition of a shield-can, the insulation coating composition comprising:
an epoxy acrylate resin at 5 wt % to 60 wt %;
a curing agent at 0.2 wt % to 10 wt %;
a surface levelling agent at 0.2 wt % to 10 wt %; and
a solvent as the remainder.

12. A method of insulation coating an inner surface of a shield-can, the method comprising:
preparing an insulation coating composition of a shield-can, which contains an epoxy acrylate resin and a curing agent and is used in a printing process for shield-can insulation coating;
coating the insulation coating composition of a shield-can on an inner surface of the shield-can by employing a printing process; and
heat-treating the coated insulation coating composition of a shield-can.

13. The method of claim 12, wherein the printing process is roll-to-roll printing, gravure printing, off-set printing, flexo printing, screen printing, inkjet printing, or a dispensing process.

14. The method of claim 12, wherein the heat-treating is carried out at a temperature in a range of 100° C. to 200° C. for 1 minute to 60 minutes.

15. The method of claim 12, wherein the insulation coating composition of a shield-can further comprises a surface leveling agent or a surfactant.
